(19) United States
(12) Patent Application Publication
(10) Pub. No.: US 2003/0209319 A1
(43) Pub. Date: Nov. 13, 2003

(54) Method of joining wood based materials

(76) Inventor: David Almqvist, Tyreso (SE)

Correspondence Address: David J. Serbin, Unit 2, First Floor, 1423 Powhatan Street, Alexandria, VA, 22314, US

(21) Appl. No.: 10/359,267

(22) Filed: Feb. 6, 2003

Related U.S. Application Data
(60) Provisional application No. 60/354,298, filed on Feb. 7, 2002.

(51) Int. Cl. B32B 35/00

(52) U.S. Cl. 156/325; 156/327

(57) ABSTRACT

The present invention relates to a method of joining two or more pieces of wood based materials, comprising the steps of providing at least two pieces of wood based material; separately applying an adhesive composition (A), comprising a curable resin, and a composition (B), comprising a gel forming substance, onto at least one of said at least two pieces; joining the two pieces together to form an assembly having the compositions (A) and (B) situated between the pieces; pre-pressing the obtained assembly, with no curing of the resin; and then, hot-pressing the assembly to cure the resin. It also relates to wood based products made by the method.

The present invention relates to a method of joining wood based materials wherein a curable adhesive composition and a composition comprising a gel forming substance are separately applied onto wood based materials. It also relates to wood based products made by the method.

### BACKGROUND OF THE INVENTION

Some processes of gluing wood based materials include a pre-pressing step followed by a hot-pressing step. This is particularly the case in gluing processes, such as manufacture of plywood and laminated veneer lumber, where a thermosetting adhesive is applied onto veneers, which are assembled and usually pre-pressed at room temperature forming an assembly of veneers. The assembly is then usually hot-pressed where the curing of the adhesive takes place. It is important that the veneers are sufficiently adhered to each other after tire pre-pressing step so that the assembly is not disrupted thereby destroying its shape. If the veneers are insufficiently adhered to each other, the assembly may also get stuck in the hot-pressing equipment. Consequently, bad cold-adhesion will lead to that some material cannot be used after pre-pressing, thus forming a waste.

When formulating a typical curable adhesive, various additives are usually mixed into a curable resin. The additives usually affect the pot life, which can be reduced from being up to several weeks for the resin alone, to only a few days or shorter for the formulated curable adhesive composition. Some additives lead to very short pot life which causes handling problems. Thus, problems with too short pot life are frequently present when formulating adhesive compositions.

In order to improve the cold-adhesion, additives such as cereal based materials including wheat flour, maize flour etc. are commonly used as components in curable adhesive compositions. However, cereal base additives can only be used up to a certain amount without thickening the adhesive composition too much. Also, different natural or synthetic polymers have been tested, but not giving any satisfactory improvement. Thus, the performance of the known additives for improving cold-adhesion is insufficient and there is a need for improving the cold-adhesion when joining wood based materials without causing problems with too short pot life.

When gluing together two surfaces, there exists a certain maximum assembly time available, i.e. the maximum length of time between application of the adhesive components and joining of the parts in, for example, a press. The assembly time must be sufficient long to enable assembling and adjusting of the parts to be glued in a practical way.

WO 89/05221 discloses a method for the production of wood products where hardener is applied in a zone along edges of a veneer layer However, due to the rapid hardener used, the assembly time before pre-pressing, will be very short. Also, the method according to WO 89/105221 may lead to variations of the quality of the adhesive bond between different parts of the adhesive bond, and more waste.

U.S. Pat. No. 4,824,896 discloses an adhesive for bonding wood pieces of high moisture content, which optionally includes borax. U.S. Pat. No. 2,889,241 discloses a phenolic resin composition comprising a boron oxygen compound, such as boric acid. EP 0259042 A2 discloses the use of esters as curing agents for a phenol-formaldehyde resin. However, none of U.S. Pat. No. 4,824,896, U.S. Pat. No. 2,889,241 or EP 0259042 A2 discloses anything about cold-adhesion.

It is an object of the present invention to provide a method for joining wood based materials which gives excellent cold-adhesion, minimises pot life problems, and gives sufficient assemby times. The method being suitable for processes where a curable adhesive composition is used comprising a pre-pressing step and a hot-pressing step. It is a further object of the present invention to provide wood based products made by the method.

### THE INVENTION

According to the invention it has surprisingly been found possible to achieve the above mentioned objects by a method of joining two or more pieces of wood based materials, comprising the steps of:

(a) providing at least two pieces of wood based material;

(b) separately applying an adhesive composition (A), comprising a curable resin, and a composition (B), comprising a gel forming substance, onto at least one of said at least two pieces;

(c) joining the two pieces together to form an assembly having the compositions (A) and (B) situated between the pieces:

(d) pre-pressing the obtained assembly, with no curing of the resin; and then

(e) hot-pressing the assembly to cure the resin.

According to the invention it has also surprisingly been found possible to achieve the above mentioned objects by a method of joining two or more pieces of wood based materials, comprising the steps of:

(a) providing at least two pieces of wood based material;

(b) separately applying an adhesive composition (A), comprising a curable resin, and a composition (B), comprising a gel forming, non-curing, substance, onto at least one of said at least two pieces;

(c) joining the two pieces together to form an assembly having the compositions (A) and (B) situated between the pieces:

(d) pre-pressing the obtained assembly: and then

(e) hot-pressing the assembly to cure the resin.

By “a gel forming substances” is herein meant a substance, which, by itself or by its derivatives, is able to make the adhesive composition (A) according to the invention from a gel, but not to make any resin in adhesive composition (A) significantly cure at the relatively low temperatures during pre-pressing, for example, at room temperature, 20-25° C., which is an example of a temperature range during pre-pressing.

By “curing” the resin is herein meant transforming the curable resin into a hardened, cross-linked, suitably solid, state.

By “pre-pressing”, is herein meant pressing at a temperature below the required curing temperature of a thermosetting adhesive composition applied, so that no significant curing takes place during the pre-pressing time.

By “cold-adhesion” is herein meant the adhesion after pre-pressing between two surfaces having a thermosetting adhesive layer between the surfaces.

By “hot-pressing” is herein meant pressing at a temperature higher than the temperature at pre-pressing, at or over the required curing temperature of a thermosetting adhesive composition applied, so that the adhesive is cured.

A suitable curable adhesive composition (A) according to the invention include any curable adhesive composition requiring an elevation in temperature to cure sufficiently fast. The adhesive composition (A) may comprise more than one resin. Suitably, the adhesive composition (A) comprises a phenolic resin or a combination of an amino resin and a non-curable resin.

Phenolic resins are condensates of different phenolic compounds and aldehydes. A phenolic compound can be phenol itself, polyhydric phenols and alkyl phenols such as resorcinol, alkyl resorcinol, cresols, ethyl phenol and xylenol, and phenolic compounds of natural origin such as tannins Examples of suitable aldehydes include formaldehyde, acetaldehyde, glutaraldehyde, propionaldehyde, n-butyraldehyde, isobutyraldehyde and furfural. A phenolic resin can exist as a solution in water, or alcohol such as ethanol. Suitably, the phenolic resin exists as an aqueous solution with varying dry content of resin. A phenolic resin used in the adhesive composition (A) according to the invention is suitably a formaldehyde-based phenolic resin such as a phenol-formaldehyde, a resorcinol-formaldehyde and a phenol-resorcinol-formaldehyde resin. Preferably, the adhesive composition (A) comprises a phenol-formaldehyde resin. The dry resin content in the phenolic resin is suitably from about 20 to about 80 weight %, preferably from about 30 to about 60 weight %, most preferably from about 40 to about 50 weight %, the remaining part of the resin preferably substantially being water. The molar ratio formaldehyde to total amount phenolic compounds (one or both of phenol and resorcinol) when making the resin is suitably from about 0.1 to about 4, for a phenol-resorcinol-formaldehyde resin preferably from about 0.5 to about 1. For a phenol-formaldehyde resin, the molar ratio phenol to formaldehyde is preferably from about 1 to about 3.

Amino resins are condensates of carbonyl compounds, such as aldehydes, with compounds containing amino, imino or amide groups such as urea, melamine, thiourea, guanamines, ethylene urea, cyanamide, dicyanodiamide and guanidine. Mostly, amino resins refer to condensates of formaldehyde and amine-containing compounds among which the most common ones are urea and melamine giving urea-formaldehyde and melamine-formaldehyde, and melamine-urea-formaldehyde. An amino resin used in the adhesive composition (A) according to the invention is suitably a urea-formaldehyde resin or a melamine-formaldehyde resin. The dry resin content in the amino resin is suitably from about 30 to about 90 weight %, preferably from about 45 to about 80 weight %, most preferably from about 55 to about 75 weight %, the remaining part of the resin preferably substantially being water. The non-curable resin is suitably a polymer comprising polar groups, preferably a polyvinylester or therefrom derived polymers, most preferably polyvinylacetate or polyvinylalcohol. The amount of non-curable resin in the adhesive composition (A) is suitably from about 0.1 to about 40 weight %, preferably from about 0.5 to about 30 weight %, more preferably from about 1 to about 15 weight %, most preferably from about 2 to about 10 weight %, calculated as dry matter non-curable resin in the whole, non-dry, adhesive composition (A). The amino resin is suitably cured by using conventional curing agents at elevated temperatures, suitably above 50° C., preferably above 80° C.

The adhesive composition (A) can be formulated in any suitable way according to the state of the art. Suitably, the adhesive composition (A) may comprise various additives, such as curing catalysts, and fillers, such as nutshell flour, or other starch-containing substances known in the art. The suitable viscosity of the adhesive composition (A) at application onto a surface of a wood based material depends on the application method used. The adhesive composition (A) has suitably a Brookfield viscosity, at 25° C., of from about 100 to about 150000 cP, preferably from about 300 to about 50000 cP

The gel forming substance is suitably a non-curing substance, by which is herein meant that a curable adhesive composition comprising the substance should not irreversibly cross-link at 20° C. even after several hours. Examples of suitable gel forming substances according to the invention include inorganic and organic gel forming substances. The inorganic gel forming substances include boron-containing compounds and metal ions. A boron-containing compound according to the invention preferably contains oxygen, most preferably the boron-containing compound is selected from the group of boric acid, borate salts, or a combination thereof. By a borate salt is herein included all types of borate salts such as metaborates, triborates, tetraborates etc. The boron-containing compound is suitably dissolved in water or organic solvents such as glycerol, ethylene glycol, diethylene glycol, methanol or ethanol. Preferably, the boron-containing compound is dissolved in water. The metal ions are preferably belonging to group 3A, or, are transition metal ions belonging to any of groups 3B to 8B in the periodic table of elements, such as zinc, zirconium and chromium. The metal ions are suitably dissolved in water. If one or more inorganic gel forming substances are used, composition (B) comprises the one or more gel-forming substances suitably in an amount of up to saturation of the gel forming substance, or substances, in the solvent used, suitably from about 0.01 to about 50 weight %, preferably from about 0.1 to about 30 weight %, more preferably from about 0.5 to about 25 weight %, most preferably from about 1 to about 20 weight %.

The organic gel forming substances according to the invention include compounds having an ester functional group. An organic gel forming substance is suitable when a phenolic resin is used in the adhesive composition (A). Suitably, such a gel forming substance is selected from the group consisting of esters, lactones, organic carbonates, or mixtures thereof. Suitable esters include, but are not limited to, methyl formate, methyl acetate, ethyl acetate, N-butyl acetate, butylene glycol diacetate, ethylene glycol diacetate and glycerol triacetate (triacetetin). Also, other aliphatic C₁-C₄ monoesters can be used, such as methylformate, ethylformate, propylformate, butylformate, methylacetate, ethylacetate, butylacetate, propylacetate, methylpropionate, ethyl propionate, propylpropionate, butylpropionate, methylbutyrate, ethylbutyrate, propylbutyrate, propylbutyrate, methylpentanate, ethylpentanate, propylpentanate, butylpentanate. Also multiesters can be used such as ethylene glycol di-alkylester, diethylene glycol di-alkyl ester, propylene glycol di-alkyl ester, butylene glycol di-alkyl ester, glycerol alkyl ester, 1,3-propanediol alkyl ester, 1,3-butanediol alkyl ester, 1,4-butanediol alkyl ester, where alkyl is C₁-C₄. Suitable organic carbonates include, but are not limited to, propylene carbonate, ethylene glycol carbonate, glycerol carbonate, 1,2-butanediol carbonate, 1,3-butanediol carbonate, 1,2-pentanediol carbonate, 1,3-pentanediol carbonate. Preferably, propylene carbonate is used. Lactones include, but are not limited to, gamma-butyrolactone, beta-propiolactone, beta-butyrolactone, beta-isobutyrolactone, beta-isopentylactone, gamma-isopentylactone, and delta-pentylactone. If an organic compound, such as a compound having an ester functional group, is used as the gel forming substance, composition (B) suitably comprises from about 1 to about 100 weight %, preferably from about 10 to about 40 weight %, of gel forming substance. The remaining part of composition (B) is suitably substantially water.

Suitably, the Brookfield viscosity of an adhesive composition (A) gelled by the gel forming substance at 20° C. should decrease when the gel is moderately heated, for example, to 50° C. This indicates that the gelling is reversible and that no significant irreversible cross-linking in the adhesive composition (A) has taken place.

The weight ratio of applied adhesive composition (A) to applied composition (B) is suitably from about 100:1 to about 2:1, preferably from about 50:1 to about 5:1, most preferably from about 30:1 to about 10:1, calculated per unit area.

The application of the adhesive composition (A) and composition (B) can be made in optional order of application. Preferably, the adhesive composition (A) is applied onto a surface before composition (B). The application of the adhesive composition (A) and composition (B) onto a wood based material can be made by using any suitable method known in the art, such as spraying, brushing, extruding, roll-spreading, curtain-coating etc. forming shapes such as droplets, one or several strands, beads or a substantially continuous layer. Preferably, the adhesive composition (A) is applied by using extruding, roll-spreading or curtain-coating methods, while composition (B) is preferably applied by spraying

Suitably, from about 20 to about 100% of the surface subjected to application of adhesive composition (A) is subjected to application of composition (B), preferably from about 50 to about 100%, most preferably from about 80 to about 100%. By “surface subjected to application” is herein meant the surface exposed to any application method, with no requirement of a certain degree of coverage of any of composition (A) or (B).

In the method according to the invention, two or more pieces of wood based materials are joined forming an assembly of pieces, which is subjected to a pre-pressing step, suitably at ambient temperature, preferably at from about 0 to about 40° C., most preferably at from about 5 to about 30° C. The pre-pressing step according to the invention is suitably performed at a pressure of from about 1 to about 50 kg/cm², preferably from about 2 to about 25 kg/cm², most preferably from about 4 to about 15 kg/cm². The pre-pressing time depends on the resin used and the type of assembly to be pressed and is suitably from about 0.1 to about 30 minutes. For a phenolic resin, the pre-pressing time is preferably from about 0.1 to about 15 minutes, even more preferably from about 1 to about 10 minutes, most preferably from about 3 to about 5 minutes. For an amino resin, the pre-pressing time is preferably from about 5 to about 30 minutes, most preferably from about 8 to about 15 minutes.

The assembly of pieces is further subjected to a hot-pressing step, which is suitably at a temperature at or above the curing temperature of the adhesive composition (A). The hot-pressing step according to the invention is suitably performed at a pressure of from about 1 to about 50 kg/cm², preferably from about 2 to about 25 kg/cm², most preferably from about 4 to about 15 kg/cm². The temperature in the hot-pressing step depends on the resin used and is suitably from about 50 to about 200° C. For a phenolic resin, the hot-pressing temperature is suitably from about 80 to about 200° C., preferably from about 120 to about 170° C. For an amino resin, the hot-pressing temperature is suitably from about 50 to about 150° C., preferably from about 90 to about 130° C. The hot-pressing time depends on the resin and the thickness of the assembly, and is suitably from about 0.01 to about 5 minutes per mm thickness of the assembly, preferably from about 0.1 to about 2 minutes per mm thickness of the assembly, most preferably from about 0.2 to about 1 minutes per mm thickness of the assembly.

In one preferred embodiment of the invention, a curable adhesive composition comprising a phenolic resin is applied onto veneers of wood whereupon a composition comprising boric acid is applied onto the applied adhesive composition. Two or more veneers are pre-pressed forming an assembly, which is thereafter hot-pressed, thereby curing the adhesive composition,

In another preferred embodiment of the invention, a curable adhesive composition comprising a combination of an amino resin and a polyvinylester is applied onto veneers of wood whereupon a composition comprising boric acid is applied onto the applied adhesive composition. Two or more veneers are pre-pressed forming an assembly, which is thereafter hot-pressed, thereby curing the adhesive composition

The wood based materials according to the method of the invention can be of any kind that can be joined by an adhesive system. Preferably, the wood-based materials are veneers or other wood based sheets.

The wood based products obtainable by the method according to the invention can be of any kind where a pre-pressing step is suitable, examples of such products are plywood, laminated veneer lumber, and flooring materials.

The invention will now further be described in connection with the following examples which, however, not should be interpreted as limiting the scope of the invention

### EXAMPLES

### Example 1

The method according to the invention was tested by gluing veneers into a two-ply panel with a standard adhesive composition made of 100 parts by weight of phenol-formaldehyde resin, 1 part of sodium carbonate, 9 parts of wheat flour and 5 parts of water. The resin had a dry content of 45 weight %. The formulated adhesive composition had a Brookfield viscosity at 25° C. of about 3000 cP. The veneers tested were Radiata Pine of 3 mm thickness. The adhesive composition was applied by extrusion into strands in an amount of 220 g/m². A composition (B) according to the invention was made comprising about 5 weight % sodium tetraborate decahydrate and about 95 weight % of water. Composition (B) was sprayed onto the applied adhesive composition in an amount of about 10 g/m². The pre-pressing was made at a pressure of 10 kg/cm² and at a temperature of 21-25° C. for 60 seconds. Three identical test panels were made and tested. The amount of surface on top and bottom of the two-ply panel that had separated (“released”) from each other was recorded after 30 minutes. Release values of 100% means total separation while 0% means that the veneers are still sticking together.

TABLE 1

| Sample | Release at 30 min (%) |
|---|---|
| 1 | 0 |
| 2 | 10 |
| 3 | 5 |
| | Average: 5% |

### Comparative Example

A test was made as in Example 1, but without spraying composition (B) onto the applied adhesive.

TABLE 2

| Sample | Release at 30 min (%) |
|---|---|
| 1 | 95 |
| 2 | 100 |
| 3 | 100 |
| | Average: 98% |

It is concluded that separate application of the components according to the invention gives a significant improvement in cold-adhesion.

### Example 2

Samples of a PF resin, and a combination of a UF resin and a polyvinylalcohol (PvAl) were tested with a gel forming substance according to the invention, and a citric acid hardener (for UF) according to WO 89/05221. 15 g of a composition comprising either 10 weight % gel forming substance or 20 weight % hardener according to WO 89/05221, was mixed with 180 g of an adhesive comprising either a PF resin or a UF/PvAl resin system. The UF/PvAl system also comprised a conventional hardener, and the relations of the components were 100 parts UF, 6 parts PvAl (17 weight %), and 20 parts hardener, Thereafter, the mixture was allowed to rest for 1 minute at 20° C. after which the appearance and viscosity were noted. Thereafter, the temperature was quickly raised to about 50° C. and the appearance and the viscosity of the sample were again noted.

TABLE 3

| | Brookfield viscosity and/or appearance | | | |
|---|---|---|---|---|
| | | | UF/PvAl | UF/PvAl |
| Added substance | PF 20° C. | PF 50° C. | 20° C. | 50° C. |
| Sodium tetraborate | 30000 cP | 3000 cP | 50000 cP | 5000 cP |
| decahydrate + | (gel) | (fluid) | (gel) | (fluid) |
| boric acid (1:1) | | | | |
| Citric acid + | —* | —* | >500000 cP | hard/brittle |
| aluminium sulphate | | | (hard gel) | |
| (WO 89/05221) | | | | |

*combination not relevant to test

It is concluded that the gel forming substances according to the invention do not irreversibly cross-link the resins at room temperature. Furthermore, a combination of a citric acid/ aluminium sulphate hardener, according to WO 89/05221, with UF/PvAl gives a hard gel already after 1 minute at 20° C., and which does not soften when heated, indicating irreversible curing.

1. A method of joining two or more pieces of wood based materials, comprising the steps of:
(a) providing at least two pieces of wood based material;
(b) separately applying an adhesive composition (A), comprising a curable resin, and a composition (1), comprising a gel forming substance, onto a surface of at least one of said at least two pieces;
(c) joining the two pieces together to form an assembly having the compositions (A) and (B) situated between the pieces;
(d) pre-pressing the obtained assembly, with no curing of the resin; and then,
(e) hot-pressing the assembly to cure the resin.

2. A method according to claim 1, wherein the adhesive composition (A) is applied before composition (B).

3. A method according to claim 1, wherein the wood based material is a veneer.

4. A method according to claim 1, wherein the adhesive composition (A) comprises a phenolic resin.

5. A method according to claim 1, wherein the adhesive composition (A) comprises a combination of polyvinylacetate or polyvinylalcohol and an amino resin.

6. A method according to claim 5, wherein the amino resin is a urea-formaldehyde resin or a melamine-formaldehyde resin.

7. A method according to claim 1, wherein the gel-forming substance is boric acid, a borate salt, or a combination thereof.

8. A method according to claim 4, wherein the gel forming substance is a metal ion belonging to group 3A, or a transition metal ion belonging to any of groups 3B to 8B, in the periodic table of elements.

9. A method according to claim 7, wherein composition (B) comprises from about 0.5 to about 30 weight % of gel forming substance.

10. A method according to claim 8, wherein composition (B) comprises from about 0.5 to about 30 weight % of gel forming substance.

11. A method according to claim 4, wherein the gel forming substance is selected from the group consisting of esters, lactones, organic carbonates, or mixtures thereof.

12. A method according to claim 11, wherein composition (B) comprises from about 10 to about 40 weight % of gel forming substance,

13. A method according to claim 1, wherein the weight ratio applied adhesive composition (A) to applied composition (B) is from about 30:1 to about 10:1, calculated per unit area.

14. A method of joining two or more pieces of wood based materials, comprising the steps of:
(a) providing at least two pieces of wood based material;
(b) separately applying an adhesive composition (A), comprising a phenolic resin, and a composition (B), comprising a gel forming substance, onto a surface of at least one of said at least two pieces, the weight ratio applied adhesive composition (A) to applied composition (B) is from about 30:1 to about 10:1, calculated per unit area;
(c) joining the two pieces together to form an assembly having the compositions (A) and (B) situated between the pieces,
(d) pre-pressing the obtained assembly, with no curing of the resin; and then,
(e) hot-pressing the assembly to cure the resin.

15. A method according to claim 14, wherein the gel-forming substance is boric acid, a borate salt, or a combination thereof, and present in an amount of from about 0.5 to about 30 weight % in composition (B).

16. A method according to claim 14, wherein the gel forming substance is a metal ion belonging to group 3A, or a transition metal ion belonging to any of groups 3B to 8B, in the periodic table of elements, and present in an amount of from about 0.5 to about 30 weight % in composition (B).

17. A method according to claim 14, wherein the gel forming substance is selected from the group consisting of esters, lactones, organic carbonates, or mixtures thereof, and present in an amount of from about 10 to about 40 weight % in composition (B).

18. A method of joining two or more pieces of wood based materials, comprising the steps of:
(a) providing at least two pieces of wood based material;
(b) separately applying an adhesive composition (A), comprising a combination of polyvinylacetate or polyvinylalcohol and an amino resin, and a composition (B), comprising from about 0.5 to about 30 weight % of boric acid, a borate salt, or a combination thereof, onto a surface of at least one of said at least two pieces, the weight ratio applied adhesive composition (A) to applied composition (B) is from about 30:1 to about 10:1, calculated per unit area:
(c) joining the two pieces together to form an assembly having the compositions (A) and (B) situated between the pieces;
(d) pre-pressing the obtained assembly, with no curing of the resin; and then,
(e) hot-pressing the assembly to cure the resin.

19. A method according to claim 18, wherein the amino resin is a urea-formaldehyde resin or a melamine-formaldehyde resin.

20. A wood based product obtained by the method according to claim 1.

21. A wood based product according to claim 20, which is plywood, laminated veneered lumber, or a flooring material.
